(19) United States
(12) Patent Application Publication
(10) Pub. No.: US 2013/0157077 A1
(43) Pub. Date: Jun. 20, 2013

(54) Novel Material Used for Bearing Ring and Production Process Thereof

(71) Applicants: Lihui Wang, Wuan (CN); Chibo Li, Wuan (CN); Shanqin Bao, Wuan (CN); Jie Gao, Wuan (CN); Yong Tang, Chengdu (CN); Yafeng Song, Wuan (CN); Xiaobin Huang, Wuan (CN)

(72) Inventors: Lihui Wang, Wuan (CN); Chibo Li, Wuan (CN); Shanqin Bao, Wuan (CN); Jie Gao, Wuan (CN); Yong Tang, Chengdu (CN); Yafeng Song, Wuan (CN); Xiaobin Huang, Wuan (CN)

(21) Appl. No.: 13/583,796

(22) PCT Filed: Jul. 29, 2011
(86) PCT No.: PCT/CN2011/077797

§ 371 Date: Sep. 10, 2012

(30) Foreign Application Priority Data
Aug. 13, 2010 (CN) 201010252962.8

(51) Int. Cl. F16C 33/62; B32B 15/01; F16C 33/64; F16C 33/14; F16C 33/12

(52) U.S. Cl. CPC F16C 33/62; F16C 33/14; F16C 33/122; F16C 33/64; B32B 15/011
USPC 428/638; 164/4.1; 428/685

(57) ABSTRACT

A novel material used for a bearing ring and a production process thereof is directed to a bimetallic composite pipe and a production process thereof. The aim of the disclosure is to provide a novel material used for a bearing ring and a production process thereof, in which high hardness, high wear resistance and high toughness, high impact toughness are interacted. The novel material used for a bearing ring according to the invention is composed of an annual clad layer and a base layer. The clad layer and the base layer is metallurgy bonded together in radial direction of a ring. The clad layer is made of bearing steel material, and the base layer is made of the material selected from bearing steel, straight carbon steel, high strength low/medium alloy steel or stainless steel.

### CROSS REFERENCE OF RELATED APPLICATION

This is a U.S. National Stage under 35 USC 371 of the International Application PCT/CN2011/077797, filed on Jul. 29, 2011.

### FIELD OF THE INVENTION

The present invention relates to a bimetallic composite pipe and a production process thereof, especially to a composite pipe made of a material used for a bearing ring and a production process thereof.

### BACKGROUND OF THE INVENTION

Material currently used for bearing is mainly divided into several kinds as following :

1) High-carbon chromium bearing steel (according to Chinese national standard GB/T 18254-2002)

High-carbon chromium bearing steel generally includes GCr9, GCr15, GCr9SiMn, GCr15SiMn and the like. GCr9 is mainly used to produce a small steel ball or a roller on rotating shaft, a bearing ring and a rolling element used in ordinary conditions; GCr15 is used to produce a steel ball, a roller or a bearing ring of a large machinery; GCr9SiMn is of performance similar to that of GCr15 and mainly used to produce a larger bearing ring; GCr15SiMn has better wear resistance and hardenability compared to GCr15 and is mainly used to produce a bearing ring, a steel ball and a roller of a large bearing.

2) Carburizing bearing steel (according to Chinese national standard GB/T3203-1982)

Carburizing bearing steel generally includes G20CrMo, G20Cr2Ni4, G20Cr2Mn2Mo, G20CrNi2Mo and the like. This kind of bearing steel is mainly used for bearing ring and rolling element withstood impact load, since this kind of steel could have better hardness and toughness after case carburized and could withstand larger impact load. Carburizing bearing steel such as G20Cr2Ni4 has HRC62 surface hardness, HRC43 central hardness, 2.3 mm carburized depth and 68.7J/cm² impact toughness after carburized and heat treated.

3) Stainless bearing steel (according to Chinese national standard GB/T3086-1982)

Currently, 9Cr18 and 9Cr18MoV are stainless bearing steel broadly used. This kind of steel is mainly used to produce a corrosion resistant bearing ring and a corrosion resistant rolling element, such as a bearing used in seawater, river, nitric acid, petrochemical and atomic reactor, etc.

4) Oil-free lubricated bimetallic bearing material

Oil-free lubricated bimetallic bearing material is made of high quality low-carbon steel with lead tin bronze alloy sintered thereon. The bearing material is made from copper-steel bimetallic strip which is high temperature sintered and densely rolled. The bearing material is adapted to produce a bushing, a thrust washer and the like which could understand middle-speed and high-speed impact load.

A rolling bearing is usually operated at higher speed or larger load, thus the rolling bearing material is required to have the following characters:

1) The material must be quenched sufficiently to get higher hardness and better wear resistance;

2) The material must have higher fatigue strength, especially shear fatigue strength of work surface;

3) It must be ensured that the bearing parts have stability in structure and dimension at working temperature;

4) The bearing withstood impact load must have higher impact resistance;

However, since hardness and wear resistance conflict with toughness and impact resistance for the same material, the requirements of sufficiently high hardness, strength and wear resistance inevitably are at the cost of reduced toughness and impact resistance of the material. Although carburizing bearing steel could meet the interaction between the work surface hardness and the overall toughness, the unevenness of carbon content of the carburized layer would significantly reduce the shear strength of the work surface. What is to be solved in the invention is how to ensure that the impact toughness of the material is maintained in the context of adequate hardness and wear resistance, but also the work surface has higher shear fatigue resistance.

### SUMMARY OF THE INVENTION

The technical problem to be solved in this invention is to provide a novel material used for a bearing ring and a process thereof, in which high hardness, high wear resistance and high toughness, high impact toughness are interacted.

The novel material used for a bearing ring according to the invention is composed of an annular clad layer and a base layer. The clad layer and the base layer is metallurgical bonded together in radial direction of them. The clad layer is made of a bearing steel material, and the base layer is made of a material selected from bearing steel, plain carbon steel, high strength low or medium alloy steel or stainless steel.

The novel material used for the bearing ring according to the invention is provided, wherein the clad layer is used as a working layer and the base layer is used as a supporting layer.

The novel material used for the bearing ring according to the invention is provided, wherein the clad layer is provided on the outside of the base layer in radial direction of the base layer.

The novel material used for the bearing ring according to the invention is provided, wherein the clad layer is provided on the inside of the base layer in radial direction of the base layer.

The novel material used for the bearing ring according to the invention is provided, wherein the clad layer is made of a high-carbon chromium bearing steel material or a stainless bearing steel material.

A process of a novel material used for a bearing ring according to the invention is carried out as follows:

(1) Selecting material, in which:

Selecting the clad layer material, i.e. bearing steel material, according to the use condition. Selecting the corresponding base layer material according to the strength requirements and the coefficient of thermal expansion of the clad layer, i.e. bearing steel material, straight carbon steel, high strength low or medium alloy steel or stainless steel. The toughness of the base layer material is higher than that of the clad layer.

(2) Centrifugal casting, in which:

A. roasting a metal pipe mold to 200-300° C. and spraying, getting 1.0-3.0mm spraying thickness;

B. roasting the sprayed metal pipe mold to 200-350° C.;

C. centrifugal casting a first layer liquid metal, clad layer liquid metal or base layer liquid metal, into the metal pipe mold of the step B and cooling;

D. numerical simulating and analyzing the heat transfer of the first metal layer which is casted and solidified, and casting a second layer liquid metal, base layer liquid metal or clad layer liquid metal, depending on the temperature analysis;

E. cooling the casted composite pipe billet to below 700° C. then demolding; and

F. heat-treating the pipe billet of the step E depending on subsequent processing conditions;

(3) Longitudinal rolling, in which:

G. machining the as-cast composite pipe billet of the step F and getting the size required as longitudinal rolling; and

H. longitudinal rolling the composite pipe of the step G, consequently forming the composite pipe ring used for the bearing ring.

The production process of the novel material used for a bearing ring according to the invention is provided, wherein the step (3) is replaced with hot extrusion, that is to say,

G. machining the as-cast composite pipe billet of the step F and getting the size required as hot extrusion; and

H. hot extrusion the composite pipe of the step G, consequently forming the composite pipe ring used for the bearing ring.

The production process of the novel material used for a bearing ring according to the invention is provided, wherein the step (3) is replaced with hot milling, that is to say,

G. machining the as-cast composite pipe billet of step F and getting the size required as hot milling; and

H. hot milling the composite pipe of the step G, consequently forming the composite pipe ring used for the bearing ring.

The production process of the novel material used for a bearing ring according to the invention is provided, wherein the step (3) is replaced with forging, that is to say,

G. machining the as-cast composite pipe billet of step F and getting the size required as forging; and

H. forging the composite pipe of the step G, consequently forming the composite pipe ring used for the bearing ring.

The production process of the novel material used for a bearing ring according to the invention is provided, wherein the heat treatment in the step F includes normalizing, spheroidizing annealing or diffusion annealing.

A bimetallic composite pipe is made of the novel material used for a bearing ring according to the invention. The pipe is composed of a clad layer which is made of bearing steel material and a base layer which is made of the material, for example, bearing steel, straight carbon steel, high strength low or medium alloy steel or stainless steel with higher toughness/impact toughness and coefficient of thermal expansion similar to that of the clad layer. Because of this, the required toughness and high impact toughness of the bearing material are dramatically improved when the performance requirement of a normal bearing steel material is ensured, so as to prevent the bearing from impacting under large impact load and simultaneously to overcome the low shear fatigue resistance of the working face of carburizing bearing steel due to the unevenness of the carburized layer.

The novel material used for a bearing ring according to the invention and the production process thereof is further described as follows in conjunction with the accompanying figures.

### BRIEF DESCRIPTION OF THE DRAWINGS

FIG. 1 is a structural schematic view of the first embodiment of the novel material used for a bearing ring according to the invention;

FIG. 2 is a structural schematic view of the second embodiment of the novel material used for a bearing ring according to the invention.

### DETAILED DESCRIPTION OF THE INVENTION

### Example 1

(1) Selecting material, in which:

The material is made of two layers: an outer layer (a base layer) is high strength low alloy steel which is 16 MnV, and an inner layer (a clad layer) is bearing steel which is GCr15.

The composition of 16 MnV (by mass) is as follows: C 0.14-0.2%, Si 0.3-0.6%, Mn 1.0-1.6%, P≦0.025%, S≦0.025%, V 0.05-0.15%, and the balance being Fe. The melting point of the material is about 1510° C., i.e. 1783.15K.

The composition of GCr15 (by mass) is as follows: C 0.95-1.05%, Si 0.15-0.35%, Mn 0.25-0.45%, P≦0.025%, S≦0.025%, Cr 1.4-1.65%, and the balance being Fe. The melting point of the material is about 1450° C., i.e. 1723.15K.

(2) Centrifugal casting, in which:

A. roasting a metal pipe mold to 250-260° C. and spraying, and getting 2.0-2.1mm spraying thickness;

B. roasting the sprayed metal pipe mold to 260-290° C.;

C. centrifugal casting 16 MnV liquid metal at 1587° C. and 360 Kg into the metal pipe mold of the step B and cooling;

D. numerical simulating and analyzing the heat transfer of the casted and solidified outer layer metal 16 MnV, then casting an inner layer GCr15 liquid metal at 1504° C. and 90 Kg when the inner surface temperature of the outer layer has reduced to 1400° C. in order to get a better integrated thickness between the inner and the outer layers; and

E. cooling the casted composite pipe to room temperature, at this time the inner layer and the outer layer is sufficiently metallurgical bonded and the metallurgical bonding thickness is 1.0-1.5 mm;

(3) hot extrusion, in which:

F. machining the as-cast composite pipe of the step E and getting the size which is Ø248/Ø142/Ø108×573 mm required as extrusion press; and

G. hot extrusion the composite pipe of the step F, at 1195° C. and 22-25 MPa, and getting 12.0 extrusion ratio and Ø90/Ø64/Ø58×5600 mm finished pipe.

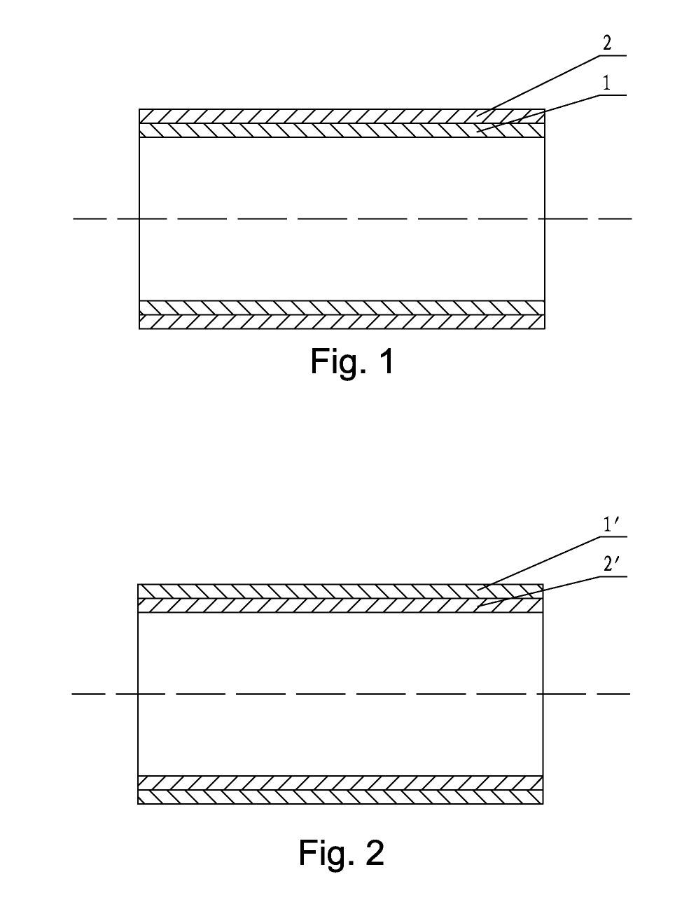

The structural schematic view of the novel material used for a bearing ring from the step G is shown in FIG. 1, in which the inner clad layer 1 is used as the working surface and the outer base layer 2 is used as the supporting layer.

### Example 2

(1) Selecting material, in which:

The material is made of two layers: an outer layer (a clad layer) is bearing steel which is GCr15, and an inner layer (a base layer) is high strength medium alloy steel which is 30CrMnSi.

The composition of 30CrMnSi (by mass) is as follows: C 0.27-0.34%, Si 0.9-1.2%, Mn 0.8-1.1%, Cr 0.8-1.1%, P≦0.035%, S≦0.035%, and the balance being Fe. The melting point of the material is about 1480-1500° C., i.e.1753.15-1773.15K.

The composition of GCr15 (by mass) is as follows: C 0.95-1.05%, Si 0.15-0.35%, Mn 0.25-0.45%, P≦0.025%, S≦0.025%, Cr 1.4-1.65%, and the balance being Fe. The melting point of the material is about 1450° C., i.e. 1723.15K.

(2) Centrifugal casting, in which:

A. roasting a metal pipe mold to 250-260° C. and spraying, and getting 2.0-2.1 mm spraying thickness;

B. roasting the sprayed metal pipe mold to 270-300° C.;

C. centrifugal casting GCr15 liquid metal at 1556° C. and 270 Kg into the metal pipe mold of the step B and cooling;

D. numerical simulating and analyzing the heat transfer of the casted and solidified outer layer metal GCr15, then casting an inner layer 30CrMnSi liquid metal at 1587° C. and 90 Kg when the inner surface temperature of the outer layer has reduced to 1387° C. in order to get a better integrated thickness between the inner and the outer layers; and

E. cooling the casted composite pipe to room temperature, at this time the inner layer and the outer layer is sufficiently metallurgical bonded and the metallurgical bonding thickness is 1.0-1.5 mm;

(3) hot extrusion, in which:

F. machining the as-cast composite pipe of the step E and getting the size which is Ø280/Ø260/Ø130×780 mm required as extrusion press; and

G. hot extrusion the composite pipe of the step F at 1200° C. and 22-25MPa, and getting 11.3 extrusion ratio and Ø139.7/Ø136/Ø118.6×7000 mm finished pipe.

The structural schematic view of the novel material used for a bearing ring from the step G is shown in FIG. 2, in which the outer clad layer 1′ is used as the working layer and the inner base layer 2′ is used as the supporting layer

### Example 3

(1) Selecting materials, in which:

The material is made of two layers: an outer layer (a base layer) is high strength low alloy steel which is 16 MnV, and an inner layer (a clad layer) is bearing steel which is GCr15.

The composition of 16 MnV (by mass) is as follows: C 0.14-0.2%, Si 0.3-0.6%, Mn 1.0-1.6%, P≦0.025%, S≦0.025%, V 0.05-0.15%, and the balance being Fe. The melting point of the material is about 1510° C., i.e.1783.15K.

The composition of GCr15 (by mass) is as follows: C 0.95-1.05%, Si 0.15-0.35%, Mn 0.25--0.45%, P≦0.025%, S≦0.025%, Cr 1.4-1.65%, and the balance being Fe. The melting point of the material is about 1450° C., i.e.1723.15K.

(2) Centrifugal casting, in which:

A. roasting a metal pipe mold to 250-260° C. and spraying, and getting 2.0-2.2 mm spraying thickness;

B. roasting the sprayed metal pipe mold to 270-300° C.;

C. centrifugal casting 16MnV liquid metal at 1576° C. and 372 Kg into the metal pipe mold of the step B and cooling;

D. numerical simulating and analyzing the heat transfer of the casted and solidified outer layer metal 16 MnV, then casting an inner layer metal GCr15 at 1555° C. and 135 Kg t when the inner surface temperature of the outer layer has reduced to 1395° C. in order to get a better integrated thickness between the inner and the outer layers; and

E. cooling the casted composite pipe to room temperature, at this time the inner layer and the outer layer is sufficiently metallurgical bonded and the metallurgical bonding thickness is 1.0-1.5 mm;

(3) Continuous rolling, in which:

F. machining the as-cast composite pipe of the step E and getting the size which is Ø220/Ø140/Ø110×2000 mm required as continuous rolling; and

G. continuous rolling the composite pipe of the step F at 1210° C. and getting Ø219/Ø198.6/Ø193×6000 mm finished pipe.

### Example 4

(1) Selecting material, in which:

The material is made of two layers: an outer layer (a base layer) is carburizing bearing steel which is G20CrNi2Mo, and an inner layer (a clad layer) is bearing steel which is GCr15.

The composition of G20CrNi2Mo (by mass) is as follows: C 0.17-0.23%, Si 0.15-0.40%, Mn 0.40-0.70%, P≦0.02%, S≦0.02%, Cr 0.4-0.6%, Ni 1.6-2.0%, Mo 0.2-0.3%, Al 0.1-0.5%, Cu≦0.2%, and the balance being Fe. The melting point of the material is about 1490° C.

The composition of GCr15 (by mass) is as follows: C 0.95-1.05%, Si 0.15-0.35%, Mn 0.25-0.45%, P≦0.025%, S≦0.025%, Cr 1.4-1.65%, and the balance being Fe. The melting point of the material is about 1450° C.

(2) Centrifugal casting, in which:

A. roasting a metal pipe mold to 250-260° C. and spraying, and getting 2.0-2.2mm spraying thickness;

B. roasting the sprayed metal pipe mold to 270-300° C.;

C. centrifugal casting G20CrNi2Mo liquid metal at 1589° C. and 204Kg into the metal pipe mold of the step B and cooling;

D. numerical simulating and analyzing the heat transfer of the casted and solidified outer layer metal G20CrNi2Mo, then casting an inner layer metal GCr15 at 1570° C. and 105Kg when the inner surface temperature of the outer layer has reduced to 1362° C. in order to get a better integrated thickness between the inner and the outer layers; and

E. cooling the casted composite pipe to room temperature and demolding, at this time the inner layer and the outer layer is sufficiently metallurgical bonded and the metallurgical bonding thickness is 0.8-1.2 mm; normalizing the finished billet at 930° C.;

(3) Milling, in which:

F. machining the as-cast composite pipe of the step E and getting the size which is Ø219/Ø162/Ø135×75 mm required as milling; and

G. Milling the composite pipe of the step F at 1180° C. and getting Ø275/Ø230/Ø211×71 mm finished ring.

After the samples of the pipe achieved from the step G of example 1, 2, 3 and 4 are heat treated according to the heat treatment process of conventional bearing steel, the base layer and the clad layer have the performance stated in table 1.

TABLE 1
the performance of the novel bearing material

| | | Base layer | | | | | | |
|---|---|---|---|---|---|---|---|---|
| | | tensile | yield | | Clad layer | | Overall performance | |
| | Heat | strength | strength | Elongation | Hardness | bulk worn | Impact | shear strength of the |
| novel bearing | treatment | (MPa) | (MPa) | (%) | (HRC) | loss (mm³) | (J) | composite layer (MPa) |
| material | process | GB 228-87 | | | GB/T 230-1991 | GB/T 12444-2006 | GB/T 229-2007 | ASTM 264-03 |
| 16MnV/GCr15 | 900° C. × 1 h, | 848.06 | 501.80 | 25.12 | 63.94 | 1.81 | 49.7 | 504 |
| (Example 1) | quenching | | | | | | | |
| | oil + 170° C. × | | | | | | | |
| | 3 h, cooling | | | | | | | |
| | by air | | | | | | | |
| GCr15/30CrMnSi | 900° C. × 1 h, | 1080 | 885 | 10 | 64.5 | 1.67 | 34 | 532 |
| (Example 2) | quenching | | | | | | | |
| | oil + 170° C. × | | | | | | | |
| | 3 h, cooling | | | | | | | |
| | by air | | | | | | | |
| 16MnV/GCr15 | 900° C. × 1 h, | 785.4 | 468.7 | 26.4 | 62.76 | 1.86 | 51 | 485 |
| (Example 3) | quenching | | | | | | | |
| | oil + 170° C. × | | | | | | | |
| | 3 h, cooling | | | | | | | |
| | by air | | | | | | | |
| G20CrNi2Mo/GCr15 | 900° C. × 1 h, | 935 | 748 | 12 | 63.5 | 1.77 | 36 | 502 |
| (Example 4) | quenching | | | | | | | |
| | oil + 170° C. × | | | | | | | |
| | 3 h, cooling | | | | | | | |
| | by air | | | | | | | |

By heat treating the novel material used for a bearing ring from the step G of above described 4 examples and a conventional production process of a bearing ring, a bearing ring is formed.

The examples above are only used to describe the preferred embodiments and are not intended to limit the present invention. It will be understood that various changes and modifications made by those skilled in the art will fall within the spirit and scope of the present invention as defined by the appended claims without departing the sprit of the present invention.

### PRACTICAL APPLICABILITY

The novel material used for the bearing ring and the production process thereof utilizes the existing metal material and the existing equipment to produce the material used for the bearing ring with excellent performance by special production process. The material used for the bearing ring may improve the performance and life of the bearing, thus having widen market prospect and strong practical applicability.

1-10. (canceled)

11. A material used for a bearing ring, comprising: a clad layer and a base layer, wherein the clad layer and the base layer are metallurgical bonded together in radial direction of them, the clad layer is made of a bearing steel material and the base layer is made of a material selected from bearing steel straight carbon steel, high strength low or medium alloy steel, or stainless steel.

12. The material used for the bearing ring of claim 11, wherein the clad layer is used as a working layer and the base layer is used as a supporting layer.

13. The material used for the bearing ring of claim 12, wherein the clad layer is provided on the outside of the base layer in radial direction of the base layer.

14. The material used for the bearing ring of claim 12, wherein the clad layer is provided on the inside of the base layer in radial direction of the base layer.

15. The material used for the bearing ring of claim 11, wherein the clad layer is made of a high carbon chromium bearing steel material or a stainless bearing steel material.

16. The material used for the bearing ring of claim 12, wherein the clad layer is made of a high carbon chromium bearing steel material or a stainless bearing steel material.

17. The material used for the bearing ring of claim 13, wherein the clad layer is made of a high carbon chromium bearing steel material or a stainless bearing steel material.

18. The material used for the bearing ring of claim 14, wherein the clad layer is made of a high carbon chromium bearing steel material or a stainless bearing steel material.

19. A production process of the material used for the bearing ring of claim 11, comprising steps of:
(1) selecting material, comprising:
selecting the clad layer material, i.e. bearing steel material, according to the use condition, selecting the corresponding base layer material according to the strength requirements and the coefficient of thermal expansion of the clad layer, i.e. bearing steel material, straight carbon steel, high strength low or medium alloy steel or stainless steel, wherein the toughness of the base layer material is higher than that of the clad layer,
(2) centrifugal casting, comprising:
A: roasting a metal pipe mold to 200-300° C. and spraying, getting 1.0-3.0 mm spraying thickness;
B: roasting the sprayed metal pipe mold to 200-350° C.;
C: centrifugal casting a first liquid metal, a clay layer liquid metal or a base layer liquid metal, into the metal pipe mold of the step B and cooling;
D: numerical simulating and analyzing the heat transfer of the first metal layer which is casted and solidified, and casting a second liquid metal, the base layer liquid metal or the clad layer liquid metal, depending on the temperature analysis;
E: cooling the casted composite pipe billet to below 700° C. then demolding; and
F: heat-treating the pipe billet of the step E depending on subsequent processing conditions; and
(3) forming the composite pipe ring used for the bearing ring.

20. The production process of the material used for the bearing ring of claim 19, wherein the step (3) comprises longitudinal rolling, comprising:
G: machining the as-cast composite pipe billet of the step F and getting the size required as longitudinal rolling; and
H: longitudinal rolling the composite pipe of the step G, consequently forming the composite pipe ring used for the bearing ring.

21. The production process of the material used for the bearing ring of claim 19, wherein the step (3) comprises hot extrusion, comprising:
G: machining the as-cast composite pipe billet of the step F and getting the size required as hot extrusion; and
H: hot extrusion the composite pipe of the step G, consequently forming the composite pipe ring used for the bearing ring.

22. The production process of the material used for the bearing ring of claim 19, wherein the step (3) comprises hot milling, comprising:
G: machining the as-cast composite pipe billet of the step F and getting the size required as hot milling; and
H: Hot milling the composite pipe of the step G, consequently forming the composite pipe ring used for the bearing ring.

23. The production process of the material used for the bearing ring of claim 19, wherein the step (3) comprises forging, comprising:
G: machining the as-cast composite pipe billet of the step F and getting the size required as forging; and
H: forging the composite pipe of the step G, consequently forming the composite pipe ring used for the bearing ring.

24. The production process of the material used for the bearing ring of claim 19, wherein the heat treatment in the step F includes normalizing, spheroidizing annealing or diffusion annealing.

25. The production process of the material used for the bearing ring of claim 20, wherein the heat treatment in the step F includes normalizing, spheroidizing annealing or diffusion annealing.

26. The production process of the material used for the bearing ring of claim 21, wherein the heat treatment in the step F includes normalizing, spheroidizing annealing or diffusion annealing.

27. The production process of the material used for the bearing ring of claim 22, wherein the heat treatment in the step F includes normalizing, spheroidizing annealing or diffusion annealing.

28. The production process of the material used for the bearing ring of claim 23, wherein the heat treatment in the step F includes normalizing, spheroidizing annealing or diffusion annealing.
